(19) United States
(12) Patent Application Publication
(10) Pub. No.: US 2013/0290871 A1
(43) Pub. Date: Oct. 31, 2013

(54) Transmedia Storytelling Tracking and Mapping System

(71) Applicants: Connie Jordan, Laguna Niguel, CA (US); Chris Carmichael, Laguna Niguel, CA (US)

(72) Inventors: Connie Jordan, Laguna Niguel, CA (US); Chris Carmichael, Laguna Niguel, CA (US)

(73) Assignee: UBIQUITY BROADCASTING CORPORATION, Irvine, CA (US)

(21) Appl. No.: 13/854,784

(22) Filed: Apr. 1, 2013

Related U.S. Application Data
(60) Provisional application No. 61/618,959, filed on Apr. 2, 2012.

(51) Int. Cl. H04L 29/06

(52) U.S. Cl. CPC H04L 65/403
USPC 715/753

(57) ABSTRACT

A transmedia mapping system

This application claims priority from Provisional application No. 61/618,959, filed Apr. 2, 2012, the entire contents of which are herewith incorporated by reference

### BACKGROUND

The availability of different electronic media allows the user to receive different information in different forms. For example, users at their computer can receive information via digital media, but they can also receive information from print media, video, film, games, online systems such as blogs and social media, advertisements, and the like. The information can be received on desktop platforms and on mobile platforms.

### SUMMARY

This application describes a mapping system that maintains information that maps different items related to a story. The items can be versions of the story e.g., as told in different media, different episodes of the same story, or interactive stories where the different versions relate to the user's location within those interactive stories.

The mapping system is carried out and stored on a computer, and determines information about the different versions of the different stories. In one embodiment, the computer maps information about at least characters, places, and times in the different stories, and creates mapping information showing information about the characters, places and times in the different stories.

The mapping system can carry out story mapping, user-specific mapping, and social mapping of the story and the way the story is being received by users.

### BRIEF DESCRIPTION OF THE DRAWINGS

FIG. 1 shows a computer system;

FIG. 2 shows a top level flowchart of operation of the computer system;

FIG. 3 shows a flowchart of story mapping in more detail;

FIG. 4 shows a flowchart of user specific mapping in more detail;

FIG. 5 shows a flowchart of social network mapping in more detail.

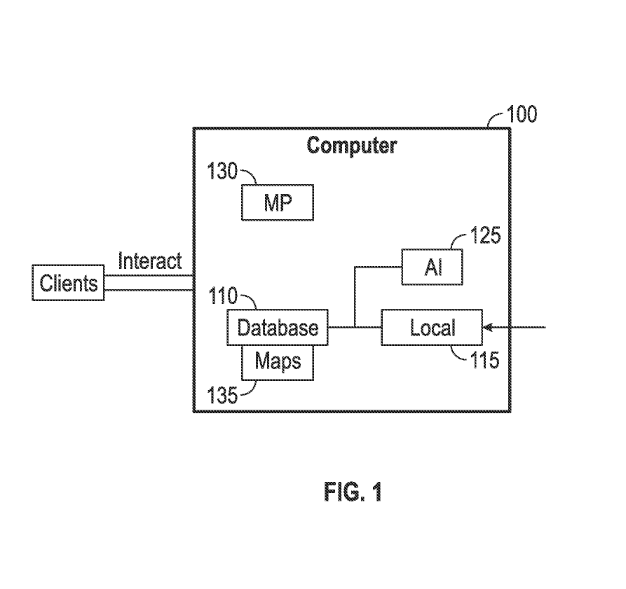

### DETAILED DESCRIPTION

The present application describes a system referred to herein as transmedia. Transmedia can be as simple as telling a story across multiple mediums and platforms such as print, digital media, video, film, games, blogs, advertisements, animation, game, billboards, art, internet, television, video game, mobile platforms, merchandise both virtual and physical, etc. As the story appears in different media, it can be described as an extension or franchise of the story, whereby each extension of the story contributes to or adds to the story itself taking on many new characteristics. However, as stories like this evolve and become more popular, different parts of the story, either different episodes or different stories as told in different media may diverge. The inventors recognize that it is important that as the different stories diverge, that all aspects of the story remain consistent so people remain interested in the story, and do not notice inconsistencies between different aspects of the story. This is done through mapping the story.

The inventors also recognize that different users may receive and for interact with the story differently, and the mapping can also include mapping that tracks what the users specifically do with the story.

The embodiments describe following the story through versions of the story as told in different media, or different episodes or spinoffs of the same story, or in interactive stories where the different versions relate to the user's location within those interactive stories.

This application describes a database of information stored on a computer and a platform for distributing the information in a way that implements a transmedia operation. An embodiment refers to this as a mapping system, that maps different characters in time, space and location, so that as the different story parts are told, the map can be used to maintain consistency. Another aspect describes using this map for analytics, which can include any use of the map.

The Star Trek franchise of stories may be used as an example. These stories are told in different locations in the universe, at different times, with different characters who often tie together. The descriptions given throughout this specification describe how the different versions—e.g., different episodes and different stories can be maintained consistent by maintaining time, space and location information into the mapping Transmedia database.

Aspects of a Star Trek story can also be interactive, and the location of the user, and what the user has done in the story, can also be tracked.

Transmedia storytelling according to the present system may require that all the stories be based on the same plot line and at least some of the same characters. However, the story is told differently on the different platforms. The way that the story is told differently is in a way that relates to the platform in one embodiment. Transmedia stories may be fiction or non-fiction. The story may be a story “line”, with any kind of ongoing plot or adaptive plot, or a reality story.

In this way, the same story can told differently on the different platforms and the differences preferably are enhanced by, or enhance, the platform. This is not the same as telling the story the same way and distributing it across multiple platforms, such as a book adapted for film or television and the marketing around those. Rather, transmedia adapts the story or plot for the different platforms in this embodiment.

In embodiments, the database is formed by starting with the origin of the story or Canon. For example: “Batman,” which started out as a comic book and then a cartoon. The story has been told across multiple mediums (film, print, text, television, cartoons, merchandise, etc.). The original Batman, including character, attributes, history, chronology, geographic location, world, etc, forms data about the Canon (origin) of the story. The database described herein stores that information as a function of multiple different parameters, enabling users to use the information to maintain consistency between the different versions of the story. The database described herein is described as mapping this information, and the mapping is carried out as a function of a number of different story parameters.

The canon and the mapping is stored in a memory 110 of the server computer 100. The memory can be a database such as a relational database that is addressable and organizable according to multiple different parameters as described herein. The canon/mapping as stored in a memory 110 can be stored in any of a number of different forms, as phrases, XML, psuedocode, or in any form. Server computer 100 also has other information that can be used as part of the story generation.

That story as told in a Transmedia platform can take on many characters, story lines, clues and other items. For example, when told on a mobile platform, the story may include links to local features that are close to the location of the mobile platform, such as local landmarks, or tie ins to local establishments. The local features may detected at 115, which can determine the location associated with a user to whom the material will be directed. The database 110 can include an advertising database. Advertising need not be consistent across multiple versions of the story, since different ads can always be added.

Sometimes when creating a transmedia story, worlds are created, with their own languages, geography, history, genealogy etc. Using the Star Trek example, the world can include Romulans and Klingons, which have their own geography, history, genealogy and language. In some of the platforms, the Transmedia database can be adaptive in placing clues distributed across the extensions of a story (Superman and the crystals, Lord of the Rings) given to help the story reader discover different parts or the story or reach different levels of the story in another form of media (extension).

Within the Transmedia distribution of a story, there are several ways utilized to tell the story that are stored within the memory of the server computer that organizes the distribution. This may include different story features for the different media.

The paper print may have the story only, and possibly drawn pictures.

Digital print may include links that are associated with the content, and may have some of the content modified so that the user is encouraged to use the links. The digital print may also have extras, e.g., spin offs and side marketing, that enhance the story if the user chooses to use them.

Other forms may include digital radio, digital cinema, documentary, text, live, music, conventions, video, user generated content, repurposed footage, television, product placement, social networking, blogs, search terms, artwork, internet, websites, bulletin boards, pay per view, photos, ringtones, stylebooks, kiosks, advertisements, holograms, radial narrative maps, theatre, theme parks, collectibles & merchandise, alternate reality games, action figures, gaming, newsletters, digital scrapbook, trading cards, coupons, animation, apps, bookmarking, timeline tagging, etc. The memory can store different versions of the basic canon for all of these, to tell a Transmedia story. Again each of those would be considered an extension or part of the story franchise. The different fields that can be used to tell the story and save information include the following: global computer networks, global cloud storage, global cloud computing, location identification, electronic reader technology, global mobile networks, global television networks, 2-D and 3-D film, digital cinema, global video game networks, global radio networks, live broadcast, software, computer chips, animated object, portable exchangeable memory chips, video games, Compact disks, electronic chips, toys, games, digital media, holograms, near field technology, Free-space point-to-point optical links, radio-frequency technology, bar codes, digital print, scanned images, smart chip, optical scanning, laser scanning, 3D object scanning or 3D laser scanning, global network crawlers, object tracking, facial recognition, digital gaming tokens, digital money, Artificial intelligence, print media, language translation technologies, symbol detection, Ultrasound imaging, manga books, satellite global positioning system technology, Satellite data communications, search engine optimization, search engine marketing global web search engine, hyperlinks, bookmarks, Social network engines, Kiosk, digital billboards, tagging, e-commerce, POS, Short Message Service, Video Chat, and Instant Messaging, mobile e-commerce, ad hock video clips, Virtual computer network, RFB protocol, File Sharing, Messaging, touch screen, near field communication and ringtones, downloadable music, and downloadable apps.

This map can be topographical, holographic, paper, printed, astrological, oceanographic, nautical, universe, geological, biological, historical, regional, political, infrastructure, physical, climate, economic or resource, road, thematic, border map, trail guide, biological classification (scientific taxonomy), DNA mapping, anatomical, object and dimension maps, architectural maps (blueprints), and migratory maps. Again, while the canon/story itself is a story, the maps 135 are an extension of that story that can form simulated maps in a simulated virtual world. There can be a number of different kinds of maps.

The maps are created as tools to facilitate the creation and following of the story versions for the different platforms. In addition, the maps that are created can themselves be distributed as part of the story, for example an add-on to the story.

For story creators and the consumers who interact with the story extensions, it is important to keep track and be able to look up numerous aspects of the story across the different extensions of the story. It is important to map and track the origins of the story and all of the aspects of the story across every alternate manifestation (extension). This is part of the analytics function of the database, described further herein.

The inventors recognize that one of the challenges facing a Transmedia story telling is keeping audiences and authors aware of how each extension relates to every other extension and where each one fits in to the larger story canon.

Keyword data compiling and storage mapping can also be used as part of the creation of the story on the different media. The keywords can be extracted from the canon, or can be specific keywords that are associated with the canon. An artificial intelligence module 125 can include a thesaurus and dictionary. The thesaurus can extend the keywords to output words that are synonyms of the keywords. The module can include a Transmedia dictionary and thesaurus with a lookup or search function so that as we come across words we do not understand that are part of fiction we can look it up and find out what that is. This can be done via lookup on the web, for example.

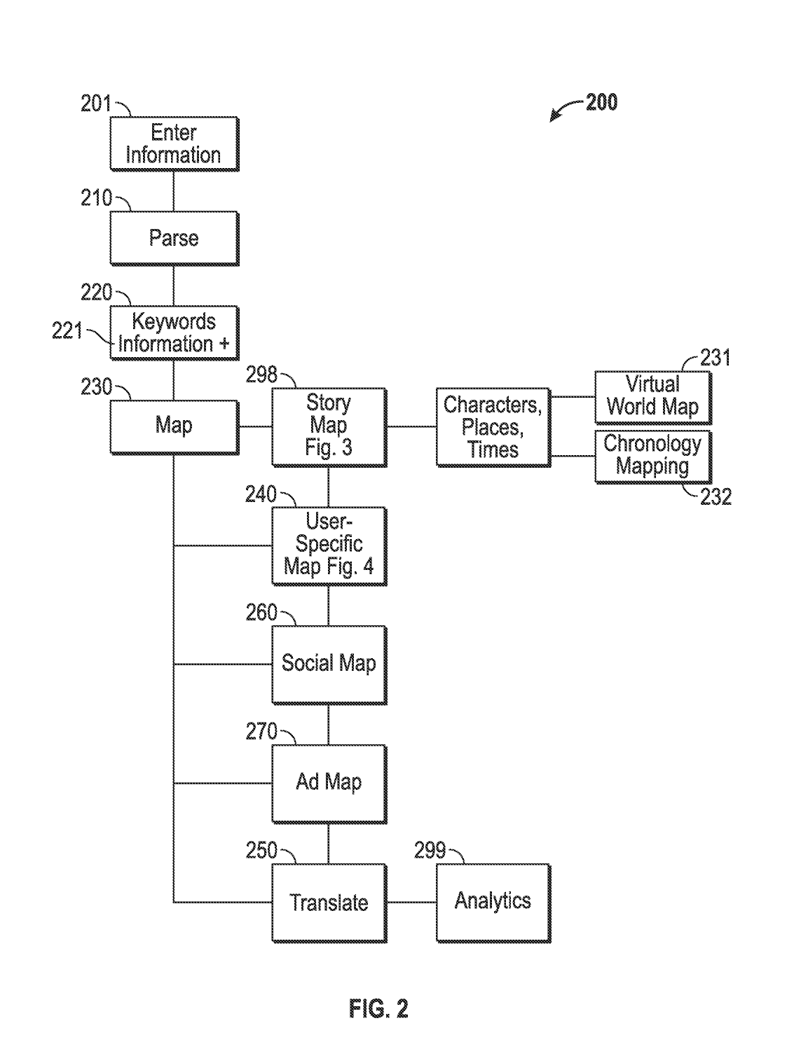

In operation, the authors may enter information into the computer as shown in the flowchart of FIG. 2 as 200. A processor 130 in the computer and/or the AI module 125 (which may be part of the processor 130) processes the information at 210 according to automatic language detection or artificial intelligence or any other technique. The processor processes the language to look for keywords. The AI module 125 looks for synonyms and other parts of those keywords. For example, the information can be entered as a basic plot line, or can be entered as complete text indicative of the book or screenplay that is going to be used.

The output of the parsing at 220 includes a number of different keywords. These keywords can be used to create the maps that are described herein. Alternatively, the maps where the information for the maps can be manually entered.

One aspect described herein carries out mapping at 230 based on the keywords. That mapping, as described herein, can carry out a story map shown as 299 that finds and maps characters, places and times. This can carry out the user specific map at 240, as described herein creating maps that show where different users have been and what the different users possess in an interactive story. This can carry out social mapping at 260, creating a map for use with a social network. Ad Mapping is carrying out at 270, that creates advertisements. All of these maps can be used within the story to weave the story better together.

The information 201 that has been entered as 200 may be marked up e.g. highlighted to create information+ as 221. The highlighted information for example may be highlighted to include the characters places and times or the information for the other maps.

A user entering the information also has the capability of manually highlighting keywords to enter other information. The point of the Transmedia operation is thereafter to maintain consistency among the characters, places and times among all the different versions of the story.

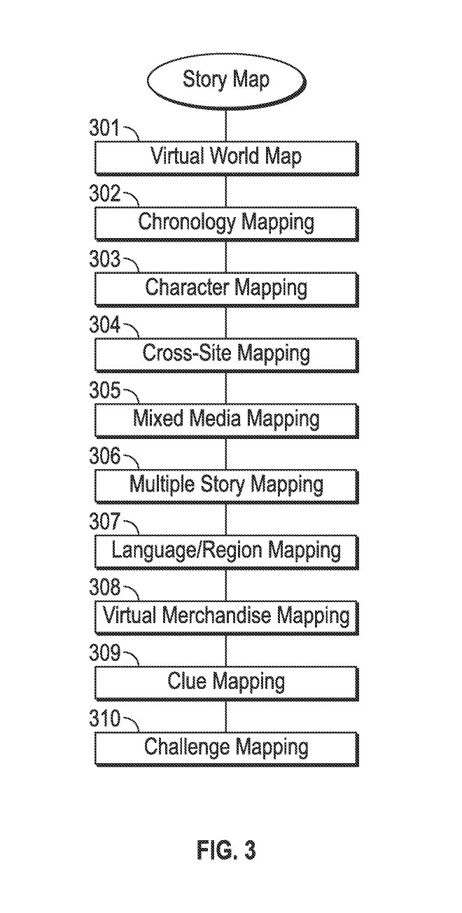

A first kind of story map is a virtual world map shown as 301 in FIG. 3. Note that this virtual world map is created based on all of the different versions of the story such as episodes and versions of the stories created across different platforms. For any information that has been entered into the system that relates to a place, the system will return information about the virtual world and the location in the virtual world, along with all the information that is already been entered about that location. This can be used as part of a world building map, which is a radial narrative map, serves as an idea igniter by mapping out what already exists and showing the empty undiscovered countries. The radial map is connected to the world map.

Other kinds of world mapping besides the virtual world mapping can also be used. For example, dimension mapping can be used to track what exists in the physical world vs. ethereal worlds. Specifically, spiritual, digital, afterlife, pre life, parallel, spatial, non-spatial, and time dimensions can be used.

Chronological mapping data compiling and storage is carried out at 302. Story tracking throughout time, both in our (real) world and in the fictional world of the story. Chronological mapping seeks to define both the timeline of the story and where users and authors are currently in the story. It may include events calendar, timeline tagging, cultural mapping, and character chronology. This may use language chronology, slang chronology mapping. The mapping may keep track of the user's location in the different stories, e.g. in a paper book, or in any other form of the story. The chronological mapping process may be triggered any time a “time” keyword is detected or flagged within the story. Again, this can be used to maintain consistency through the story, since it can prevent a character being in two places at the same time in different versions of the story, or can prevent different characters taking actions which are inconsistent through different versions of the story. As an example, at different times within the Star Trek saga, the federation was alternately at war with the Klingons or allies with the Klingons. The chronological mapping of 302 can be used to keep track of the kinds of things that are happening at different times. For example for a specific time, in the Star Trek example a stardate, this system can keep track of different actions which are occurring in the simulated kingdom.

Character mapping is also carried out at 303, based on the characters identified in the keyword parsing of 221. Character mapping is identifying various characters in the story throughout the various dimensions and time, i.e. character chronology and specific characteristics of said characters, both physiological and personal and social and biographical across the multiple extensions. This maps character progress, lifestyle characteristics and any character transformations (including physical characteristics) are across all extensions. Again, this keeps the characters looking and being consistent at the same time. While character appearances may change over time, the character mapping can be carried out as a function of the other mappings to maintain the consistent appearance at all times.

Other kinds of mapping can also be carried out as described below. This in all the mapping described herein is based on data compiling and storage of all connections between different characters across all extensions.

Cross sited mapping is shown at 304. In Transmedia, a story can be told across a multitude of media extensions. For instance, distinct parts of the story can be told via print, video, television, or audio media, games, film, e-books, toys, cards, tokens, animation. Finding the source point for a particular part of the story and what medium it is found in. In the case where the story is mixed between different forms or sites, this mapping may keep track of which parts of the story are found in different platforms. This is carried out as part of the entering information, where the information is entered as a function of the platform on which is going to be used.

Mixed Media Mapping is shown at 305. This is similar to cross sited mapping except in this case it maps stories that are used in different extension or objects such as print, video, film, e-books, television or audio media, games, toys, cards, tokens, animation whereby authors or users enact stories by recombining the extensions of the story with the mixed to make alternate versions of the story or continuations of the story. The new extension or alternate version of the story is then mapped.

Multiple Story Mapping is shown at 306, and is an exception to the maintenance of continuous story lines by mapping of parallel narratives across the media, mapping the stories within a story, mapping the ties within a story to alternate versions, narratives or spinoffs.

Language Translation dictionary and region mapping is shown at 307. Non Fictional/Fictional language definitions and slang translations is carried out along with regional mapping of dialects of the language or slang across all extensions. This can be shown as a translation module 250 associated with the maps and keywords. In addition, however, this may translate different parts of the story into different cultural abstractions, for example concept may better translate in different cultures into different abstractions.

Virtual merchandise mapping is carried out at 308. This is tracking and mapping of virtual merchandise used in storytelling. ie: Objects or weapons used to achieve a certain outcome across all extensions. This includes tracking and mapping, data compiling and storage of virtual merchandise owned by a consumer interacting with the story that is used in the story across all extensions. Part of this is also the tracking and mapping of virtual merchandise used in storytelling that is available for sale across all extensions, both online and offline. The virtual merchandise mapping includes On line off line Merchandise Tracking Mapping, data compiling and storage: Tracking and mapping of all merchandise used in storytelling across all of the extensions that is available for sale both online and offline. This can include, for example, object technology and costume mapping, mapping and tracking of objects, buildings, weapons, transportation vehicles, technologies, clothing, protective gear, hard goods, soft goods, furnishings, dishes, robots, machinery, holographic devices, time travel devices, and merchandise used by the characters within the story, showing which objects have been translated into real world merchandise for sale, across all extensions.

309 includes clue mapping, that does data compiling and storage of clues and codes. This carries out the tracking and Mapping of all clues or codes used within the storyline across all of the extensions. In this way, the clues can be consistent among the different versions of the story.

310 is story level or level challenges tracking and Mapping, data compiling and storage. This tracks and maps all story levels or level challenges that exist within the storyline across all of the extensions.

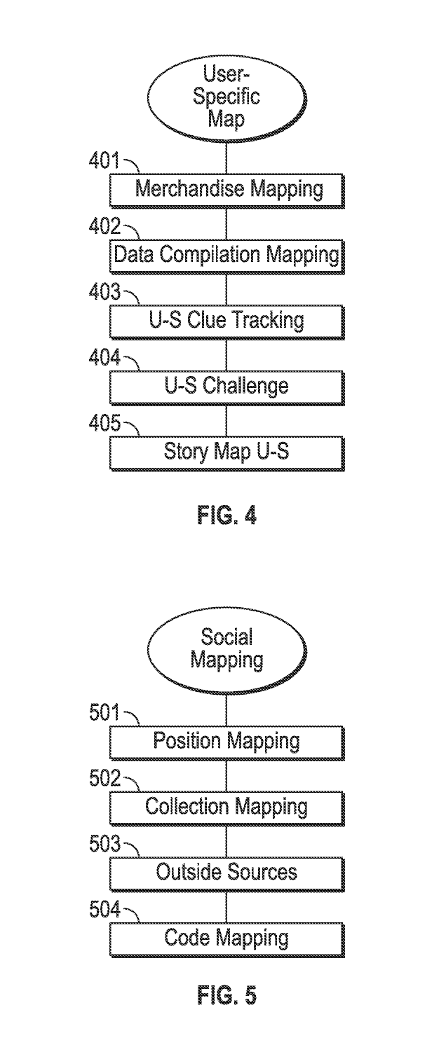

The above maps have been primarily maps which are related to the story as the story mapping 299. This relates to how the story is told across the various extensions. However, mapping can also be carried out as a user specific map at 240. For example, this can be used in interactive games such as massively multiplayer games. In 240, information that is specific to the users “account” can be mapped. This is shown in Figure detail in FIG. 4.

Merchandise mapping at 401 carries out tracking and mapping of all online and offline merchandise that is owned by the user and is based on interacting with the story across the extensions. Each of plural different users, therefore, can have their own merchandise map. For example the merchandise map, like all of the other user specific maps can be individual for different users, or can be a multidimensional array that has different information for different users.

At 402, data compilation tracking is carried out for mapping and data compiling and storage of points or credits earned. This can be tracking and mapping of all points or credits earned by the consumer interacting with the story or by others or groups interacting with the story across the extensions. This tracking can include a ranking system; however this tracking system may track the progress across multiple dimensions.

User-specific clue tracking and mapping of all clues or codes used within the story and discovered by the consumer interacting with the story across the extensions is followed at 403. This is an example of one of the mapping systems that exists both in the game specific and the user specific category. Clue mapping at 309 is paralleled by the user specific mapping at 403.

404 is another user specific mapping of mapping the challenges, comparable to a user specific version of the challenge map 310. This tracking and mapping data carries out compiling and storage of all story levels or level challenges achieved by the consumer interacting with the story across all of the extensions.

Story Mapping is shown at 405. This is Mapping and Tracking the progress of the story across each extension, Mapping the shared metrics or clues, mapping and tracking progress of a user i.e.: areas already visited, conquered or levels achieved across the various extensions. Mapping all areas across the extensions that may have been bookmarked. This tracks what parts of the story a user has consumed and what they have not, giving the user the opportunity to fill the missing gaps in his or her storyline across all extensions.

In addition to the story mapping at 299, the user specific mapping at 240, there is also social mapping that is carried out at 260. This is mapping that is optimized for using the system along with a social network. This can carry out tracking and Mapping of all individuals or groups interacting with or following the storyline or characters within a story line in each extension or/and the extensions as a whole. Mapping and tracking of consumers interacting with the storyline as a particular character identity within the story line across each extension or/an extensions as a whole is carried out at 260 in a way that produces outputs that can be reasonably used on a social network.

This is shown in more detail in FIG. 5.

501 includes position mapping, following the progress of the user across the story and outputting information to the social network site that indicates the user's position in the story.

502 includes collection mapping, which maps the different things such as merchandise that a user may have. For example, this may map all merchandise of any kind or nature or use or associated with the storyline across the extensions and mapping the individual consumers items collected against all items collectable across the extensions. Virtual storage of merchandise collected can also be carried out in this way. The merchandise may be real or virtual or a mix of both across the extensions. One of the items that can be collected, for example is multimedia clips, such as videos and music. This maps all the music of any kind or nature used in the storyline across the extensions and mapping the consumers interacting with the storyline purchased or downloaded music against all music that is collectable across the extensions by cataloging the virtual storage of the music collected. The music may be downloadable or available online or offline and provides information about what the user has in their personal collection to the social network. This can be used in the social network, so that different people can see what is in other people's personal collections. Other things that can be collected include memorabilia, which carries out the mapping and Tracking of all creator commentary about the storyline and creator(s) memorabilia that exist in any form across all extensions. This can be Inclusive of interviews, videos, photos, books, merchandise, papers, blogs etc.

502 again outputs information of the items that are in the user's collection in a way that can be used by a social network or a social networking process that communicates with this system.

503 maps the different kind of information that has been written from outside sources about the story in all its different forms. This can include for example Mapping and Tracking of Print or digital editorial, articles, blogs. Mapping and tracking of all of Print or digital editorial, articles blogs discussing the story line across the extensions. This is inclusive of all written, digital, video, photo stories. By mapping the outside stories in this way, the social network receives information indicative of these different stories. The outside sources can be from within the social network, so there can be users within the social network who are creating information related to the stories, and that can also be mapped in the social network.

Interactive Code mapping of public codes is carried out at 504. Tracking and mapping all codes that provide access to alternate extensions, mediums, stories, or interactive media across all extensions. These can include public codes that allow users to access the alternate dimensions, as compared with private codes.

One function that can be carried out by the social networking operation at 260 is that of a Digital Scrapbook. The mapping of all video, photos, news stories, quotes, advertisements, artwork and characters across the extensions and its creators. The user can pull together the different information to create such a digital scrapbook.

Another kind of mapping that can be carried out is advertising mapping as shown at 270. This carries out the mapping and tracking of all advertisements of any kind or nature inclusive of ad chronology, characters and storylines portrayed in the ad, products portrayed in the ad, across the extensions. For example, this can be used in conjunction with the local information at 115.

Tracking and Mapping Analytics and story operations is shown being carried out at 280. This can use any of the mapping kind of information to carry out analytics. Since this system includes social network information personal information and story information, the analytics can indicate the kind of person the kind of person their friends with, and what they do relative to progress in the story. In addition to tracking the analytics, 280 represents using the information in the mapping database for any purpose, including using it to determine consistency of the story. In one embodiment, artificial intelligence within the processor 130 is used programmatically in order to determine if anything in the story that has been added is inconsistent with anything else. For example, any new screenplay were story may be parsed to determine if characters, places or times are inconsistent with any previous story lines among information that is within the database.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other kinds of mapping can be carried out, and the system can be used with other kinds of websites. While the system describes entering the information and parsing it, different forms of getting the information into the database can be used for example artificial intelligence system for automated summarization system can be used to automatically look on the web for hits to keywords, and attempt to add them to the database.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form. This may include laptop or desktop computers, and may also include portable computers, including cell phones, tablets such as the IPAD™, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non transitory computer based instructions. An exemplary storage medium is coupled to the processor such that the processor can read information from, and write information to, the storage medium. In the alternative, the storage medium may be integral to the processor. The processor and the storage medium may reside in reconfigurable logic of any type.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of mapping among multiple versions of a story, comprising:
using a computer for determining information about a number of different versions of at least one story, where the different versions have related story lines, and for determining information about at least characters, places, and times in the different versions, and creating mapping information showing information about the characters, places and times in the different versions, said mapping information including both story specific mapping that is specific to multiple versions of the same story to all users, and also including user specific mapping that is specific to different users and can be different for the different users in the same story.

2. The method as in claim 1, wherein the method carries out mapping of places in the multiple versions of the stories, to make sure the details of the places are consistent among the details of the story.

3. The method as in claim 1, wherein the method carries out mapping of chronology within the story, to ensure that details of the chronology are consistent among the multiple versions of the story.

4. The method as in claim 1, wherein the method carries out mapping of characters within the story to ensure that details of the characters are consistent at different times among the multiple versions of the story.

5. The method as in claim 1, wherein the information in the maps are used to maintain a consistent story line among multiple different versions of the story.

6. The method as in claim 1, wherein said user specific mapping finds a user's location in the story among multiple different locations of progressing through the story.

7. The method as in claim 6, wherein said information for the users further comprises tracking different clues which have been given to the users.

8. The method as in claim 1, further comprising mapping information about user interaction with the story, and using said information about said user interaction to display the information to others as a social network display.

9. The method as in claim 1, where the versions of the story are as told in different media, or different episodes of the same story, or interactive stories where the different versions relate to the user's location within those interactive stories.

10. A system for mapping among multiple versions of a story, comprising:
a computer, operating for determining information about a number of different versions of at least one story, where the different versions have related story lines, and for determining information about at least characters, places, and times in the different versions, and creating mapping information showing information about the characters, places and times in the different versions, said mapping information including both story specific mapping that is specific to multiple versions of the same story to all users, and also including user specific mapping that is specific to different users and can be different for the different users in the same story.

11. The system as in claim 10, wherein the system carries out mapping of places in the multiple versions of the stories, to make sure the details of the places are consistent among the details of the story.

12. The system as in claim 10, wherein the system carries out mapping of chronology within the story, to ensure that details of the chronology are consistent among the multiple versions of the story.

13. The system as in claim 10, wherein the system carries out mapping of characters within the story to ensure that details of the characters are consistent at different times among the multiple versions of the story.

14. The system as in claim 10, wherein the information in the maps are used to maintain a consistent story line among multiple different versions of the story.

15. The system as in claim 10, wherein said user specific mapping finds a user's location in the story among multiple different locations of progressing through the story.

16. The system as in claim 10, wherein said user specific mapping maps different clues which have been given to the users.

17. The system as in claim 10, further comprising mapping information about user interaction with the story, and using said information about said user interaction to display the information to others as a social network display.

18. The system as in claim 10, where the versions of the story are as told in different media, or different episodes of the same story, or interactive stories where the different versions relate to the user's location within those interactive stories.
